(19) United States
(12) Patent Application Publication
(10) Pub. No.: US 2012/0279213 A1
(43) Pub. Date: Nov. 8, 2012

(54) COOLING TOWER APPARATUS AND METHOD WITH WASTE HEAT UTILIZATION

(75) Inventors: Spencer D. Conard, Charlotte, NC (US); Eric Rasmussen, Overland Park, KS (US); Glenn S. Brenneke, Lee's Summit, MO (US); Eldon F. Mockry, Lenexa, KS (US)

(73) Assignee: SPX Corporation, Charlotte, NC (US)

(21) Appl. No.: 13/553,552

(22) Filed: Jul. 19, 2012

Related U.S. Application Data
(63) Continuation-in-part of application No. 12/610,743, filed on Nov. 2, 2009.
(60) Provisional application No. 61/149,614, filed on Feb. 3, 2009.
(60) Provisional application No. 61/139,399, filed on Dec. 19, 2008.

(51) Int. Cl. F28C 1/00; F02G 1/043

(52) U.S. Cl. 60/517; 62/121; 62/259.4; 60/645

(57) ABSTRACT

A cooling tower system is provided that can exhibit increased energy efficiency that cools a process fluid or the like. The cooling tower system includes a cooling tower unit and a thermoelectric device along with a working fluid loop. The process fluid may be used to heat a working fluid for the thermoelectric device before being sent to the cooling tower for cooling. Power generated by the thermoelectric device may be utilized to operate a component of the cooling tower such as a fan or a pump. The cooling tower is also utilized to provide cooling to condense the working fluid from a vapor to a liquid form wherein the cooling tower is used to remove waste heat from a process fluid.

### CLAIM FOR PRIORITY

The present application is a Continuation-In-Part application that claims priority to U.S. patent application Ser. No. 12/610,743, filed Nov. 2, 2009, entitled Cooling Tower Apparatus and Method with Waste Heat Utilization; which claims priority to U.S. Provisional Patent Application No. 61/139,399, filed Dec. 19, 2008, entitled Cooling Tower Apparatus and Method with Waste Heat Utilization and U.S. Provisional Patent Application No. 61/149,614, filed Feb. 3, 2009, entitled Cooling Tower Apparatus and Method with Waste Heat Utilization, each of the disclosures of which is hereby incorporated by reference in its entirety.

### FIELD OF THE INVENTION

The invention pertains generally to cooling tower systems such as atmospheric cooling towers which are used to cool a relatively warm or hot fluid by circulating the fluid through the tower using ambient air to cool the fluid. Some embodiments of the present invention also pertain to energy systems used in conjunction with such cooling towers.

### BACKGROUND OF THE INVENTION

Atmospheric cooling towers are in wide use in industry. These towers receive a relatively warm or hot fluid, and pass the fluid through the tower apparatus so that heat is extracted from the fluid by interaction with relatively cooler ambient air. In some instances, the fluid entering the tower is a process fluid that has been heated by an industrial operation. Also, in some instances, intermediate fluid loops with heat exchangers are used in between the originally hot process fluid and the other fluid actually circulated through the tower.

Industrial cooling towers come in a wide variety of types including, by way of example only, splash bar type wet cooling towers, fill pack type wet cooling towers, dry cooling towers, hybrid wet/dry cooling towers, and dry air cooled condensers. The cooling towers often are designed such that they require a supply of electrical energy or other work energy to drive mechanical systems such as fans and/or pumps which may be present.

Additionally, waste heat expansion engines are known for generating power from exit fluid from power plants, and can require a cooling system such as a cooling tower for condensing the working fluid used in the heat engine. Such expansion engines are also interchangeably referred to herein as waste heat expansion engines or waste heat engines. It is also known to use heat from solar ponds to drive expansion engines and to use cooling towers to cool the expansion engine working fluid in that context.

It would be desirable to reduce the energy consumption of cooling towers, and hence improve the energy efficiency of the towers.

### SUMMARY OF THE INVENTION

The present invention in some embodiments relates to a method for operating a cooling tower system for cooling a heated process fluid, which has a component that requires power for operation and has an expansion engine. The expansion engine supplies a process fluid to a heat exchanger to heat a working fluid passing through the heat exchanger, and generating power by expansion of the heated working fluid, which provides generated power from the expansion engine to the component for operation thereof. The process utilizes the cooling tower to cool the working fluid from the expansion engine and to cool the process fluid after it has passed through the heat exchanger.

Some further embodiments of the present invention include a cooling tower system for cooling a supply of fluid to be cooled, which has a cooling tower unit having a component that requires power for operation, and a waste heat engine that generates power from heat transfer from the fluid to provide at least some of the power required to operate the component.

Yet another embodiment involves a cooling tower system for cooling a power plant fluid with an elevated temperature, having a component to be powered. The system has power generation means for generating power from waste heat from said fluid, which includes a working fluid that expands to form an expanded vapor. The system also has means for providing the power to the component, and cooling means for cooling the power plant fluid and condensing the expanded vapor working fluid into a liquid form.

Further embodiments provide a method for operation of a cooling tower. An expansion engine is connected to the cooling tower for providing power to a fan of the tower. A working fluid circuit is provided in communication with the expansion engine. The working fluid is heated in the circuit with heat from an exit fluid of the power plant and the heated working fluid is expanded in the expansion engine to generate power for powering the fan. The working fluid is in the form of a vapor upon exit from the expansion engine. The cooling tower is utilized to remove heat from the working fluid vapor to condense the working fluid into a liquid form, and cools the exit fluid from the power plant after the exit fluid has been utilized to heat the working fluid.

Another embodiment provides an operating method for a cooling tower system at a power plant having a component that requires power for operation and an expansion engine. Heat is exchanged from a waste heat fluid from the power plant to a working fluid. The heated working fluid is expanded in the expansion engine to generate power. The generated power from the expansion engine is provided to the component for operation thereof. The cooling tower is utilized to cool the working fluid from the expansion engine and to cool the waste heat fluid after it has heated the working fluid.

Another embodiment of the present invention provides a method for operating a cooling tower system for cooling a heated process fluid, wherein the system employs a component that requires power for operation, comprising: supplying the process fluid to a heat exchanger to heat a working fluid passing through the heat exchanger; generating a voltage by passing heat from the working fluid through a thermoelectric device to a heat sink; and utilizing the cooling tower to cool the working fluid from the thermoelectric device.

In yet another embodiment of the present invention, another method for operating a cooling tower system for cooling a heated process fluid is provided, wherein the system employs a component that requires power for operation, comprising: supplying a cooling tower fluid to a heat exchanger; supplying the heated process fluid to the heater exchanger, wherein heat exchange occurs between the heated process fluid and the cooling tower fluid whereby said cooling tower fluid cools the heated process fluid and the cooling tower fluid is heated; generating a voltage by passing the heat from the heated cooling tower fluid through a thermoelectric device to a heat sink; and utilizing the cooling tower to cool the cooling tower fluid from the thermoelectric device.

In still another embodiment of the present invention, a cooling tower system for cooling a fluid is provided comprising: a component that requires power for operation; a heat exchange device, wherein said heat exchange device includes a thermoelectric device disposed thereon, wherein said thermoelectric device generates a voltage from the heat transferred from the fluid to be cooled to a heat sink that provides at least some of the power required to operate the component.

In another embodiment, a cooling tower system for cooling an industrial process fluid is provided, comprising: a heat source loop connected to a heat source that provides hot fluid; a working fluid loop thermally connected to said heat source loop via a heat exchange device, wherein said working loop comprises a thermoelectric device; and a cooling tower fluid loop thermally connected to said working fluid loop wherein said cooling tower fluid loop comprises a cooling tower.

In still another embodiment of the present invention, a cooling tower system for cooling an industrial process fluid is provided, comprising: means for supplying the process fluid to a heat exchange means to heat a working fluid passing through the heat exchange means; means for generating a voltage by passing the heated working fluid through a thermoelectric means; and means for utilizing the cooling tower to cool the working fluid from the thermoelectric means

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a system according to a preferred embodiment of the invention.

FIG. 2 is a more detailed diagram of an example of a system according to FIG. 1.

FIG. 3 is a diagram according to an exemplary embodiment.

FIG. 4 is a diagram of an individual cooling tower utilized in conjunction with another embodiment.

FIG. 5 is a diagram of yet another embodiment.

FIG. 6 is a diagram similar to FIG. 2 but of a different alternative embodiment.

FIG. 7 is a diagram of another alternative embodiment.

FIG. 8 is a diagram of another alternative embodiment.

FIG. 9 is a diagram of another alternative embodiment.

FIG. 10 is a diagram of another alternative embodiment.

FIG. 11 is a schematic diagram of a system in accordance with an alternative embodiment of the present invention.

FIG. 12 is a schematic diagram of a system in accordance with another embodiment of the present invention.

### DETAILED DESCRIPTION

Some embodiments of the present invention provide for combining an expansion engine with a cooling tower at a power plant (or other additional process plants) to achieve both (i) cooling for the plant exit fluid (for example, steam or hot water), and/or (ii) cooling for condensation of the expanded working fluid of the expansion engine. This can provide efficiency in the operating energy consumption of the cooling tower by utilizing waste heat from the exit fluid of the power plant. The waste heat is converted by a heat engine into electrical energy or mechanical work energy which can be used to supply power to some or all of the cooling tower components, such as fans and/or pumps. Examples of some preferred embodiments will now be described with reference to the drawing figures, in which like reference numbers refer to like parts throughout.

FIG. 1 is a basic diagram of an exemplary embodiment of the present invention. A heat source loop 10 is thermally connected to a working fluid loop 12. The working fluid loop 12 is thermally connected to a cooling tower fluid loop 14.

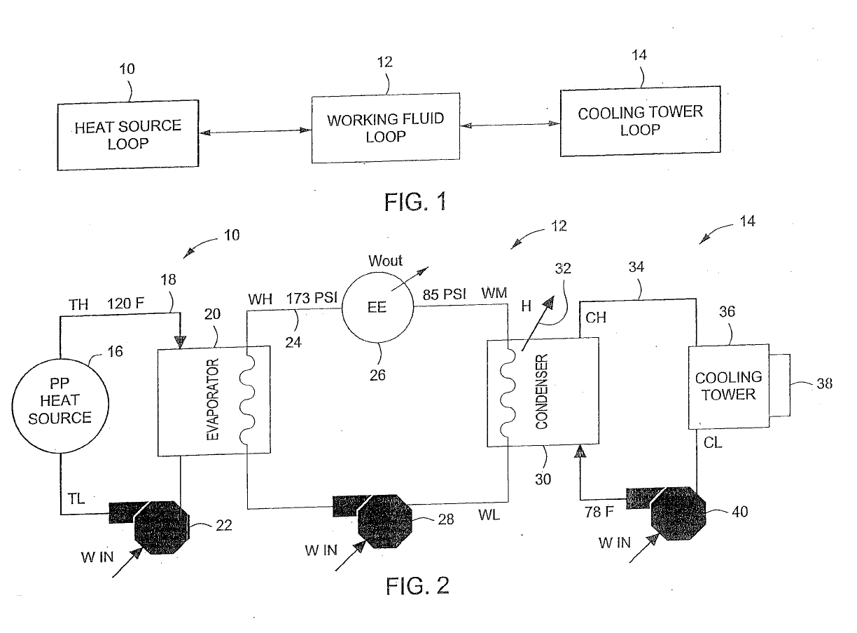

FIG. 2 shows an example of a system according to FIG. 1 in more detail. The heat source loop 10 includes a power plant or heat source 16. The power plant can be any type of system or apparatus that produces heat. The words power plant, process plant and heat source are used interchangeably herein. Examples of such power plants include electric power generation plants, steels mills, pulp and paper process plants, manufacturing facilities, semiconductor fabrication facilities, pharmaceutical process plants, petrochemical process plants, industrial facilities, refrigeration systems and HVAC systems. Those power plants may discharge hot fluids from equipment such as injection molding machines, air compressors, autoclaves, furnaces, mills, chillers, condensers, rollers, die casters, extruders, heat exchangers, oil coolers, welders, vacuum pumps, reactors and/or dehydration equipment.

The power plant 16 discharges hot fluid typically in the form of hot water or steam, into a conduit loop 18. Different power plants produce a wide range of different output temperatures, but some examples that may occur include 200° F. steam or 120° F. hot water. The exit temperature from the power plant is labeled as TH. This hot fluid is passed through an evaporator 20 and exits at a temperature TL which is lower than TH and the fluid at temperature TL is returned to the power plant. The heat source loop 10 may include some form of power operated devices such as a pump and this is illustrated by the component 22 which receives mechanical or electrical energy illustrated as Win.

The working fluid loop 12 begins at the evaporator 20 and is a closed loop system that circulates working fluid. The working fluid typically will be a refrigerant; however, any of various working fluids can be used with the system 10, and a suitable working fluid for a particular application of the system will involve considerations of environmental issues, flammability, toxicity, and the like. The selection can be made from several general classes of working fluids commonly used in refrigeration. A first general class is hydrocarbons, including propane (R290), isobutane (R600a), n-butane (R600), cyclopropane (RC270), ethane (R170), n-pentane (R601), and isopentane (R601a). A concern with this first class is the flammability of the compounds; on the other hand, they have no adverse effect on the earth's ozone layer, are not generally implicated in global warming, and have low environmental impacts in production. A second general class is chlorohydrocarbons (e.g., methyl chloride (R40)). A third general class is chlorofluorocarbons (e.g., trichlorofluoromethane (R11), dichlorodifluoromethane (R12), monofluorodichloromethane (R21), and monochlorodifluoromethane (R22), and trichlorotrifluoroethane (R113), as well as R114, R500, and R123 (or HCFC-123)). A concern with the second and third classes is the adverse effect of these compounds, when released into the environment, on the earth's ozone layer. A fourth general class is fluorohydrocarbons (e.g., tetrafluoroethane (R134a), pentafluoroethane (R125), R502, R407C, R410, and R417A, and HFE-7000). A fifth general class is other compounds such as ammonia (R717), sulfur dioxide (R764), and carbon dioxide. Benefits of the fluorohydrocarbons are their inertness and non-flammability. Some of these compounds currently have environmental and/or toxicity concerns associated with them. Another class of working fluids that may be advantageous for some uses is nanofluids, or liquids that contain dispersed nano-sized particles. Water, ethylene glycol, and lubricants can successfully be used as base fluids in making nanofluids. Carbon, meals, and metal oxides can serve as nanoparticles. In the evaporator 20, the relatively hot temperature TH from the process fluid heats and/or pressurizes the working fluid to a higher temperature and/or pressure condition WH at conduit 24. The relatively hot and/or high pressure working fluid is passed through a waste heat expansion engine EE 26, and is discharged from the waste heat expansion engine 26 at a lower temperature and/or pressure. The expansion engine provides mechanical or electrical work output illustrated by Wout. The working fluid exiting the expansion engine EE is at a reduced temperature and/or pressure WM and is passed to a condenser 30. The condenser 30 cools and condenses the working fluid to a low temperature and/or pressure WL, resulting in a heat output 32. The cooled and/or condensed working fluid is returned to the evaporator 20. An energy consuming system such as a pump 28 may be utilized to circulate the fluid, and this device can require mechanical or electrical energy illustrated by Win.

The cooling tower loop 14 receives relatively warm cooling fluid from the condenser 30 at a warm temperature CH and passes it via conduit 34 to the cooling tower 36. The cooling tower 36 may have a fan 38 and other associated mechanical systems such as a pump 40, both of which require some mechanical or electrical energy Win. The cooling tower fluid enters the cooling tower 36, where it is cooled in the cooling tower 36 by contact with ambient air, and exits the cooling tower at a lower temperature CL than it entered. The lower temperature cooling tower fluid is returned to the condenser 30 which further cools the working fluid.

In some embodiments, the evaporator 20 and/or the condenser 30 incorporate plate heat exchangers, including, for example, multi-plate, brazed, stainless steel heat exchangers.

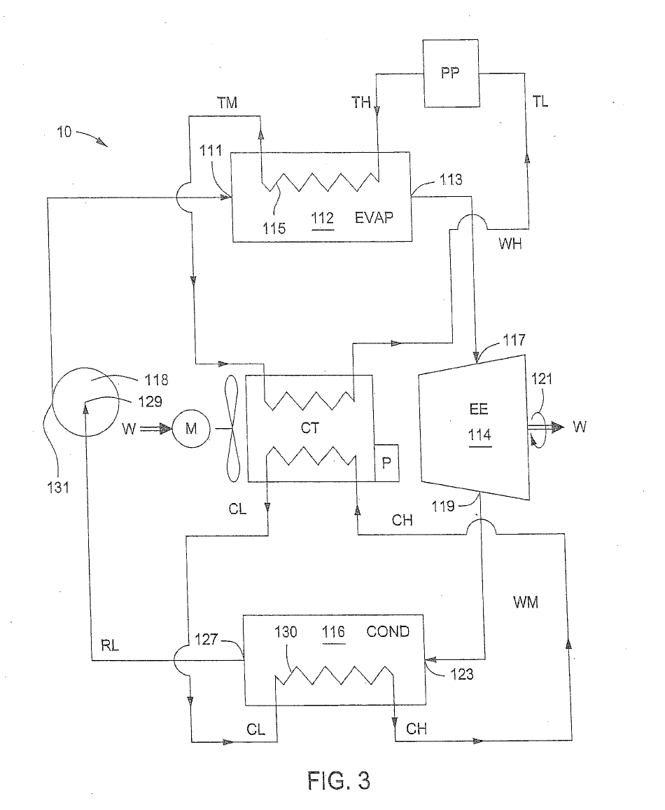

Referring now to FIG. 3, a heat loop 10 is depicted having an evaporator 112 having an inlet 111 and an outlet 113 and connected to receive a liquid working fluid and vaporizing said liquid to a vapor on input of heat from a heat source input such as a heat exchanger 115. The loop 10 further includes a positive displacement device 114 such as a rotating expander, e.g., a scroll or gerotor, used in expansion mode and an inlet 117 and outlet 119 adapted for receiving and expanding said vapor from said evaporator outlet 113 at high pressure to produce a work output 121 and providing said vapor at low pressure at said outlet 119. The loop 10 also comprises a condenser 116 having an inlet 123 for receiving said vapor from said expander outlet 119 and condensing said vapor back to a fluid liquid and a pump 118 with an inlet 129 and outlet 131 for taking the fluid liquid from condenser outlet 127 at low pressure and providing it to the inlet 111 at high pressure.

Moreover, FIG. 3 shows the adaptation of the system of U.S. Pat. No. 7,062,913 to a cooling tower CT. Specifically, the power plant PP generates hot process fluid at a temperature TH which is supplied to the evaporator 112. The process fluid exits the evaporator 112 at a medium temperature TM and is supplied to the cooling tower CT. The process fluid is cooled by the cooling tower and exits the cooling tower at a low temperature TL where it is returned to the power plant. Further, hot fluid CH from the condenser 116 is supplied to the cooling tower CT where it is cooled to a lower temperature CL, and it is returned to the condenser 116 at the lower temperature CL. This improves the efficiency of the condenser 116. The working fluid circulates as described in U.S. Pat. No. 7,062,913 and thus enters the device 114 at a hot working temperature from the evaporator and leaves the device 114 at a lower temperature WM. The device labeled 114 can in a preferred embodiment be a waste heat expansion engine, and thus can be any type of waste heat expansion engine, for example a rotary vane turbine such as a power steering pump, not merely the device disclosed in U.S. Pat. No. 7,062,913.

The work W generated by the waste heat expansion engine 114 is labeled as output 121. This work W can be supplied to the cooling tower to drive a fan motor M and/or pump P that may be associated with the cooling tower. The work can be supplied as rotational mechanical work by gears and/or a belt and pulleys or can be supplied as electricity by a generator.

There are a wide variety of examples of waste heat engines that may be utilized in some or all embodiments of the present invention. By way of example only, the heat engine can be an organic rankine engine, or a piston type expansion engine. Also by way of example, embodiments of the present invention may also employ thermoelectric or ferroelectric devices.

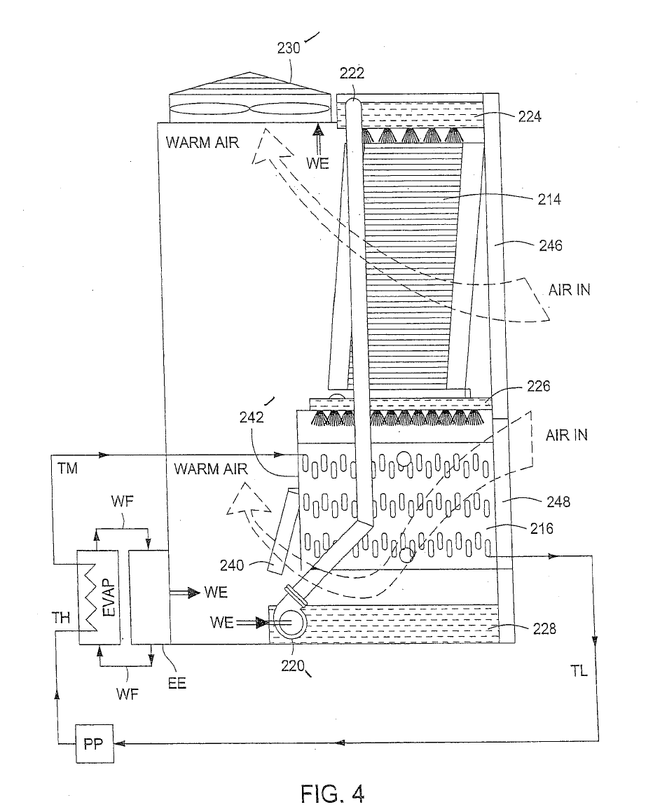

FIG. 4 is a diagram of a hybrid type closed circuit cooling tower used with a heat engine. This example uses several system components that are disclosed in U.S. Pat. No. 7,062,913, which is hereby incorporated by reference in its entirety. For clarity, FIG. 3 of the present application utilizes components illustrated in FIG. 1 of U.S. Pat. No. 7,062,913. Reference numbers present in FIG. 1 of that patent have been modified by adding the number 1 in front of them such that the component labeled 14 in U.S. Pat. No. 7,062,913 is labeled as component 114 in FIG. 3 of the present application. Thus, these components can be, for example, substantially as described in U.S. Pat. No. 7,062,913 and their description is not repeated here due to the incorporation by reference.

Turning back to FIG. 4, a power plant PP generates hot fluid or steam at a high temperature TH which is supplied to an evaporator EVAP. This cools the process fluid to a medium temperature TM at which point it is supplied to coils 242. The process fluid is cooled in the coils 242 by the cooling tower processes and exits the coils 242 at a temperature TL where it is returned to the power plant PP. Working fluid is passed between the evaporator and the expansion engine EE. The expansion engine EE generates work energy WE which can be supplied to the pump 220 and/or the fan 230.

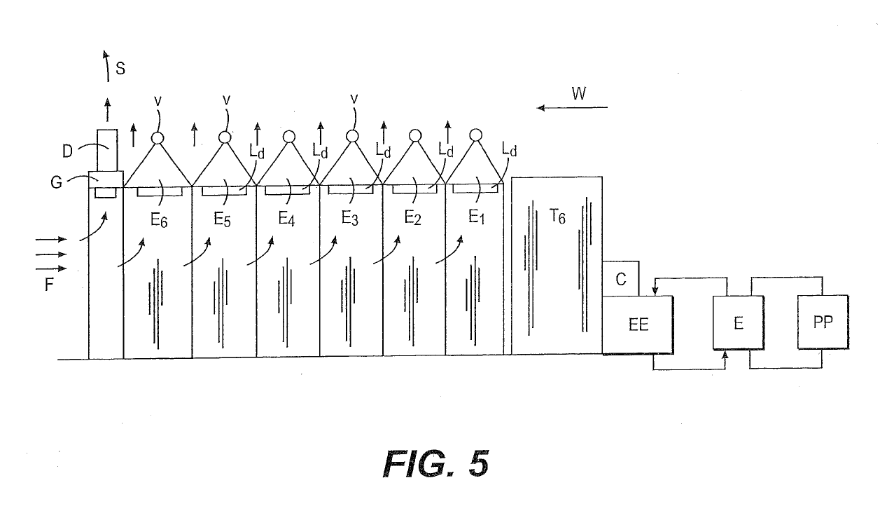

FIG. 5 depicts an embodiment where an expansion engine EE is utilized in conjunction with an air cooled condenser system. FIG. 4 is a diagram of a hybrid type closed circuit cooling tower used with a heat engine. This example uses several system components that are disclosed in U.S. Pat. No. 4,580,401, which is hereby incorporated by reference in its entirety. For clarity, FIG. 3 of the present application utilizes components illustrated in FIG. 1 of U.S. Pat. No. 4,580,401. Thus, these components can be, for example, substantially as described in U.S. Pat. No. 4,580,401 and their description is not repeated here due to the incorporation by reference. The system utilizes a condenser C, evaporator E, and power plant PP in similar conceptual fashion as the other embodiments.

More specifically, as can be seen in particular depicted in FIG. 5, each heat exchange element E is constructed in a roof-shaped manner of finned tubes; a steam distribution line V forms the ridge of the respective heat exchange element E. All of the ridges of the heat exchange elements E which are associated with a given turbine housing T are disposed parallel to one another as well as parallel to the front side of the turbine housing T. The heat exchange elements E associated with a given turbine housing T communicate via a main line H with the turbine, which is not illustrated in the drawing. As a result, at the edge of the condenser system which extends parallel to the turbine housing T a concentrated air draft S is blown out, the flow velocity of which is greater than the outlet velocity of the cooling air from the heat exchange elements E₂ to E₅ which are located in the middle. The concentrated air draft S forms a sort of aerodynamic wall. As a result of this aerodynamic wall, even a cross wind W which is coming from the direction of the turbine housing T, as indicated, is deflected upwardly, so that even in this unfavorable situation of a strong cross wind, the exhaust air which is warmed up in the heat exchange elements E₁ to E₆ reached higher air layers. concentrated air draft S also can be produced at the free edge of the condenser system by separate air conduits which are disposed along the free edge of the condenser system and are provided with appropriate air outlet openings. These air conduits are supplied with air from, for example, a central blower.

The concentrated air draft S emerges from nozzles D which, in addition to effecting an additional acceleration of the air draft S, also effect the concentration thereof. As illustrated, these nozzles D can be individual nozzles, each of which has associated therewith a fan L or a blower G.

Turning back to FIG. 4, the hybrid type closed circuit cooling tower is depicted in more detail. In particular, the fans 230 provide a pressure differential drawing air upward and out of the cooling tower. Thus, in the upper portion of the cooling tower, air is drawn into the air inlet 246 and passes across the upper fill media 214, before exiting the fill media 214 and being drawn upward and outward from the tower. The relatively warm cooling water which is pumped into the upper water distribution system 224, exits through nozzles and falls over the upper evaporative fill pack 214, is cooled by transportation therethrough, and is collected in the intermediate water distribution assembly 226.

The relatively cool cooling water after it is distributed by the intermediate water distribution assembly 226 passes over the lower heat exchanger 216, picking up heat and evaporatively exchanging heat to air while doing so, and falls into the lower collection basin 228, from which it is recirculated by the pump 220. The intermediate water distribution assembly 226 performs a further function of separating the two major air flows of the cooling tower. That is, the intermediate distribution assembly 226 separates the upper air flow, which is passing across the upper fill material 214 from the lower air flow which is passing over the lower heat exchanger 216. The lower heat exchanger 216 has at its air outlet side a side wall barrier or baffle 242, and a drift eliminator 240 disposed in the angled orientation generally depicted.

The above examples each illustrate a power plant that provides a hot fluid or steam and each illustrate all of the three loops being return loop systems. However, in some environments, it may be permissible or desirable to simply discharge the liquid which is exiting either the heat source loop or the cooling tower loop instead of recycling it.

A wide variety of cooling towers can be used with embodiments of the present invention, including types of cooling towers not illustrated in the Figures. Also, systems can be made utilizing package type cooling towers, and can be made to be mounted on a skid.

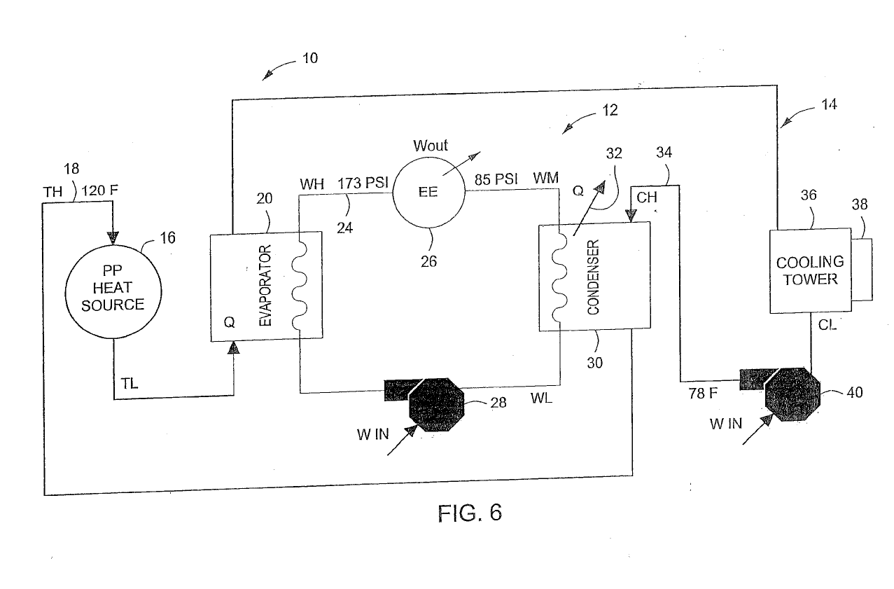

FIG. 6 is a diagram similar to FIG. 2 but of a different alternative embodiment. This embodiment uses two closed loops instead of the three loops of FIG. 1. One loop is working fluid between the evaporator and condenser, with the expansion engine EE located on the working fluid loop as shown, providing work to the working fluid loop and/or to the cooling tower loop. The cooling tower loop passes through the cooling tower, power plant PP, the evaporator and the condenser.

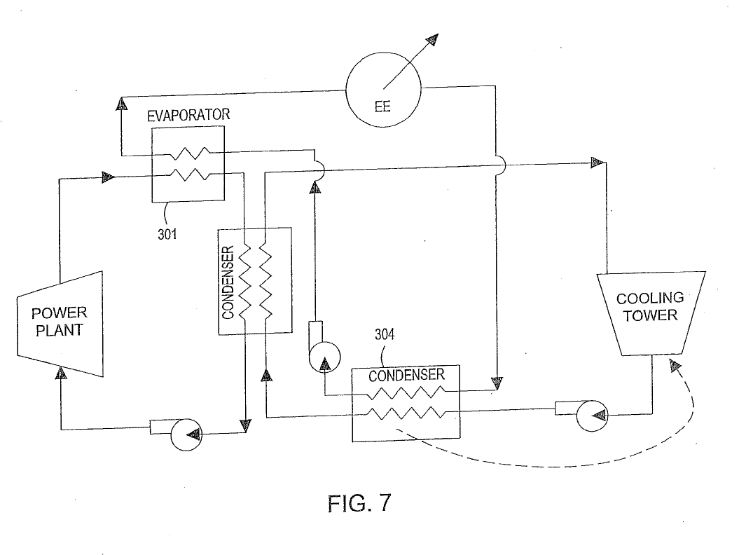

FIG. 7 is a diagram of another alternative embodiment, utilizing three loops as shown. The evaporator 301 before the heat engine EE is in front of a main condenser 304 to tap the highest potential system temperature. If the system involves steam driving a turbine in the power plant PP, the temperature can be 200 degrees F. or higher. In the embodiment the condenser 304 can be located at the cold water basin of the cooling tower.

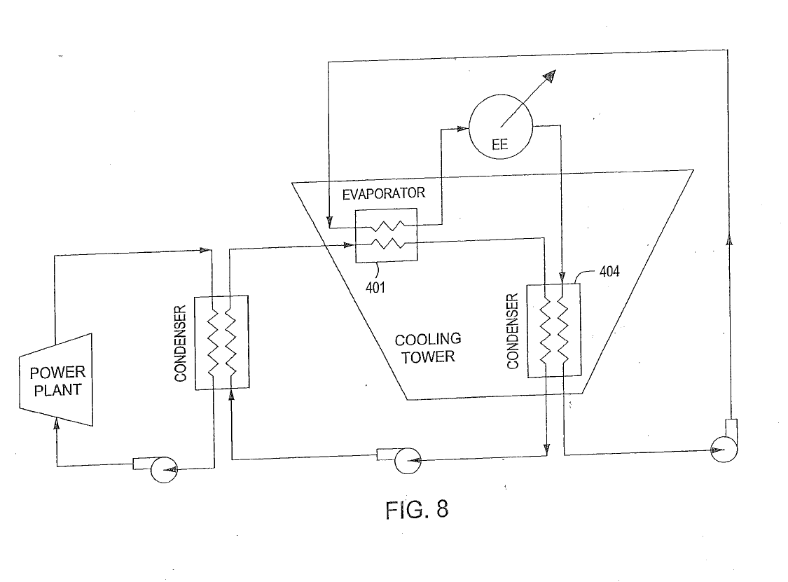

FIG. 8 is a diagram of another alternative embodiment. In this embodiment, the heat engine evaporator 401 and the condenser 404 are integrated with the cooling tower, which arrangement may be easier to package in some applications. In the embodiment, the heat source for the evaporator is at a lower temperature than the embodiment of FIG. 7.

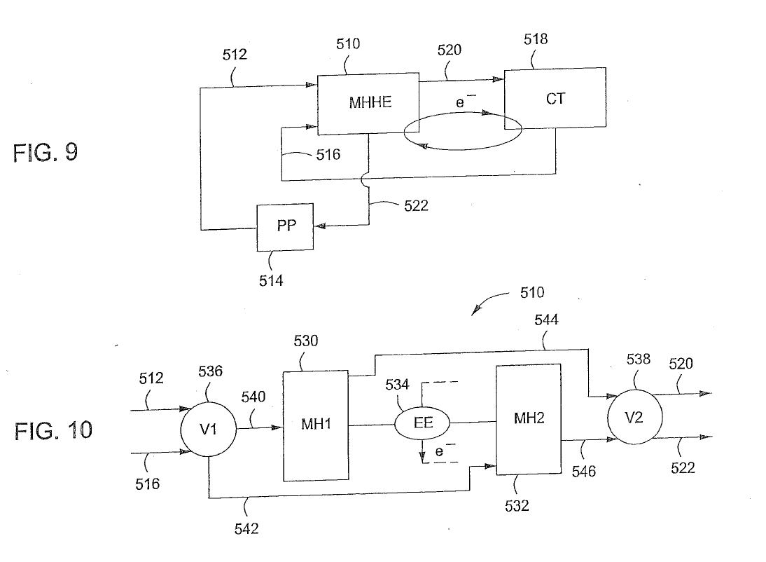

Another heat engine that can be utilized in the present invention is a metal hydride heat engine. Compressors and pumps powered by hydrogen gas pressure differentials between metal hydrides at different temperatures are disclosed in Golben et al U.S. Pat. No. 4,402,187 and Golben U.S. Pat. No. 4,884,953 both of which are incorporated by reference. As shown in FIG. 9 of the present specification, a metal hydride expansion engine system 510 receives hot (or warm) fluid 512 (water or steam for example) from a power plant 514 and receives relatively cold (or cool) fluid 516 (water for example) from the cooling tower 518. The temperature difference between the fluids 512, 516 drives the engine system 510 and generates electricity to power at least some of the cooling tower equipment (for example a fan or pump). The hot fluid stream 520 exits the engine 510 and is supplied to the cooling tower 518. The cold fluid stream 522 exits the engine 510 and flows to the power plant 514. The hot and cold fluid streams 512, 516 may only be a fraction of the entire hot and cold fluid streams between the power plant and the cooling tower depending on how much electricity generation is desired. As shown in the FIG. 10, the metal hydride expansion engine system 510 may comprise a first metal hydride unit 530, a second metal hydride unit 532, an expansion engine electrical generator 534, a first valve device 536 and a second valve device 538. The first valve device 536 allows for switching of the hot fluid stream 512 between the first metal hydride unit 530 and the second metal hydride unit 532 via conduits 540 and 542, and allows for switching of the cold fluid stream 516 between the second metal hydride unit 532 and the first metal hydride unit 530 via conduits 542 and 540. While one metal hydride unit is in the presence of cold fluid the other metal hydride unit is in the presence of hot fluid thereby creating a pressure differential which allows hydrogen gas to flow between the metal hydride units and drive the expansion engine electrical generator to produce electricity to power cooling tower equipment such as a fan or a pump. Fluid exits the first metal hydride unit 530 via conduit 544 to second valve device 538 and exits the second metal hydride unit 532 via conduit 546 to second valve device 538. The second valve 538 allows for switching of flows from conduits 544, 546 to respective streams 520, 522 so that stream 522 remains the cold fluid stream and stream 520 remains the hot fluid stream. When the flow of hydrogen decreases between the metal hydride units and power production decreases then the switching of the valves 536, 538 allows the hydrogen flow to be reversed between the metal hydride units 530, 532 and drives the expansion engine electrical generator 534.

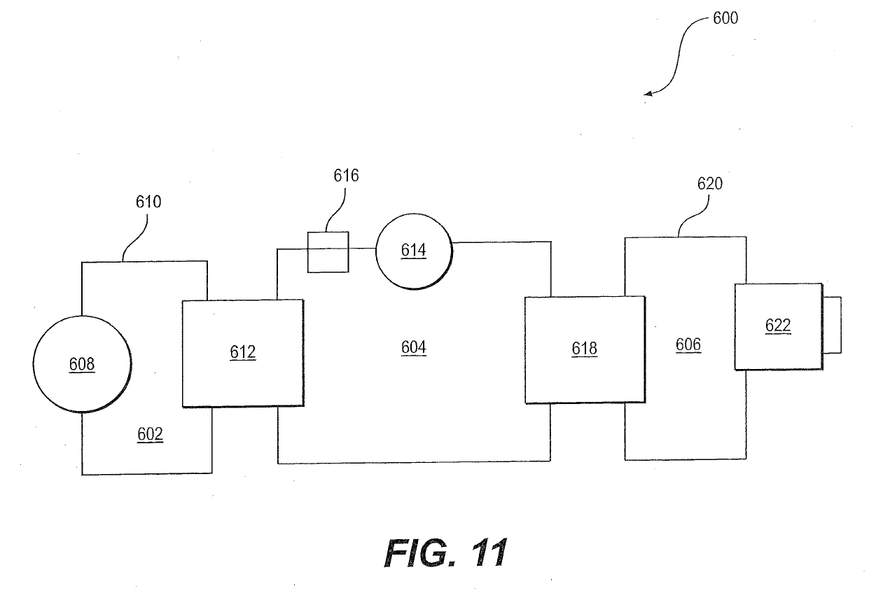

Turning now to FIG. 11, an alternative embodiment of the present invention is depicted. Whereas the prior embodiments employed a heat expansion engine or the like only, the embodiment depicted employs both a heat engine and a thermoelectric device as will be described in further detail below. A cooling tower system, generally designated 600, is illustrated. Similar to the previously described embodiments, the embodiment illustrated in FIG. 11 combines an expansion engine with a cooling tower at a power plant (or other additional process plants) to achieve both cooling for the plant exit fluid (for example, steam or hot water), and/or cooling for condensation of the expanded working fluid of the expansion engine. However unlike the previously described embodiments, the system 600 also employs a thermoelectric device in addition to the expansion engine. This can provide improved efficiency in the operating energy consumption of the cooling tower by utilizing waste heat from the exit fluid of the power plant.

As illustrated in FIG. 11, the system 600 includes a heat source loop that is thermally connected to a working fluid loop 604. The working fluid loop 604 is connected to a cooling tower loop 606. Turning specifically to the heat source loop 602, it includes a heat source such as a power plant or the like 608. The power plant 608 may be any type of system or apparatus that produces heat, for example, electric power generation plants, steels mills, pulp and paper process plants, manufacturing facilities, semiconductor fabrication facilities, pharmaceutical process plants, petrochemical process plants, industrial facilities, refrigeration systems and HVAC systems.

During operation, the power plant 608 discharges hot fluid typically in the form of hot water or steam, into a conduit loop 610 of the heat source loop 602. As discussed in connection with the previous embodiments, different power plants produce a wide range of different output temperatures, but some examples that may occur include 200° F. steam or 120° F. hot water. This hot fluid is passed through an evaporator or heat exchanger 612 and exits at a temperature which is lower than the temperature with which it entered the evaporator or exchanger 612 and is returned to the power plant 608. As previously discussed, the heat source loop 602 may include some form of power operated devices such as a pump or the like to move the fluid.

The working fluid loop 604 begins at the evaporator 612 and is a closed loop system that circulates a working fluid. As illustrated in FIG. 11, the working loop 604 employs an expansion engine 614 and a thermoelectric device 616. While the expansion engine 614 and the thermoelectric device 616 are depicted in series on the working fluid loop 604, this is exemplary only and the heat engines 614 and thermoelectric device 616 may be positioned at varying desired locations on the loop 604.

The thermoelectric device 616 may be any device that allows for, provides or otherwise produces a thermoelectric effect, i.e., the direct conversion of temperature differences to electric voltage and vice-versa. The thermoelectric device 616 may be any device or apparatus that creates a voltage when there a temperature difference on each side of the device.

Generally speaking, thermoelectric devices, or thermoelectric power generators, have the same basic configuration a standard configuration. Such configuration typically includes a heat source that provides the high temperature, and the heat flows through a thermoelectric converter to a heat sink, which is maintained at a temperature below that of the heat source. The temperature differential across the converter produces direct current (DC) to a load (RL) having a terminal voltage (V) and a terminal current (I). There is no intermediate energy conversion process. For this reason, thermoelectric power generation is classified as direct power conversion. The amount of electrical power generated is given by I²RL, or VI.

Thermoelectric power generators vary in geometry, depending on the type of heat source and heat sink, the power requirement, and the intended use. For example, in one embodiment encompassed by the present invention, a thermoelectric generator consists of a p-type and n-type semiconductors connected in series. This structure can be used to convert heat energy to electricity by using a principle known as the Seebeck effect. When heat is applied to one surface of the thermoelectric generator, the electrons in the n-type semiconductor and the holes in the p-type semiconductor will move away from the heat source. This movement of electrons and holes gives rise to an electrical current. The direction of the current is opposite to the movement of the electrons, and in the same direction as the movement of the holes. By creating the appropriate electrical connections, the current of the thermoelectric generator flows in a closed loop through the p-type and n-type semiconductors and an external load. This pair of n-type and p-type semiconductors forms a thermocouple. A thermoelectric generator can consist of multiple thermocouples connected in series, which increases the voltage output, and in parallel to increase the current output. Conversely, when a voltage is applied to a thermoelectric generator, it creates a temperature difference. Some examples of such devices may include a chip like device or apparatus, or a heat exchange apparatus having a coating or the like that allows or produces the thermoelectric effect. Such devices will employ leads or the like that allow for the current generated by the thermoelectric device to be drawn from said device.

Other examples of thermoelectric generators include fossil fuel, solar source and nuclear fueled devices. As the name suggests, fossil fuel generators are designed to use natural gas, propane, butane, kerosene, jet fuels, and wood, to name but a few heat sources. Commercial units are usually in the 10- to 100-watt output power range. Solar thermoelectric generators are typically used in remote areas and underdeveloped regions of the world and have been designed to supply electric power in orbiting spacecraft. Nuclear thermoelectric devices use the decay products of radioactive isotopes can be used to provide a high-temperature heat source for thermoelectric generators.

Turning back to the working loop 604, it employs a working fluid which typically will be a refrigerant however, any type of working fluid may be used with the system 600. A suitable working fluid for a particular application of the system will involve considerations of environmental issues, flammability, toxicity, and the like. The selection can be made from several general classes of working fluids commonly used in refrigeration. As discussed in connection with the previous embodiments, some of these compounds have environmental and/or toxicity concerns associated with them. Another class of working fluids that may be advantageous for some uses is nanofluids, or liquids that contain dispersed nano-sized particles. Water, ethylene glycol, and lubricants can successfully be used as base fluids in making nano-fluids.

During operation, the relatively hot and/or high pressure working fluid is passed through the waste heat expansion engine 614 and thermoelectric device 616 and is discharged at a lower temperature and/or pressure. The expansion engine 614 as previously discussed provides mechanical or electrical work output while the thermoelectric device provides additional electric output. The working fluid exiting the expansion engine 614 and thermoelectric device 616 is at a reduced temperature and/or pressure and is passed to a condenser 618. The condenser 618 cools and condenses the working fluid to a low temperature and/or pressure, resulting in a heat output as discussed in connection with the previous embodiments. The cooled and/or condensed working fluid is then returned to the evaporator 612.

Turning now to the cooling tower loop 606, it receives relatively warm cooling fluid from the condenser 618 and passes it via conduit 620 to the cooling tower 622. The cooling tower 622 as previously described may have a fan and other associated mechanical systems such as a pump (not pictured), both of which require some mechanical or electrical energy. The cooling tower fluid enters the cooling tower 622, where it is cooled in the cooling tower 622 by contact with ambient air, and exits the cooling tower at a lower temperature than it entered. The lower temperature cooling tower fluid is returned to the condenser 618 which further cools the working fluid.

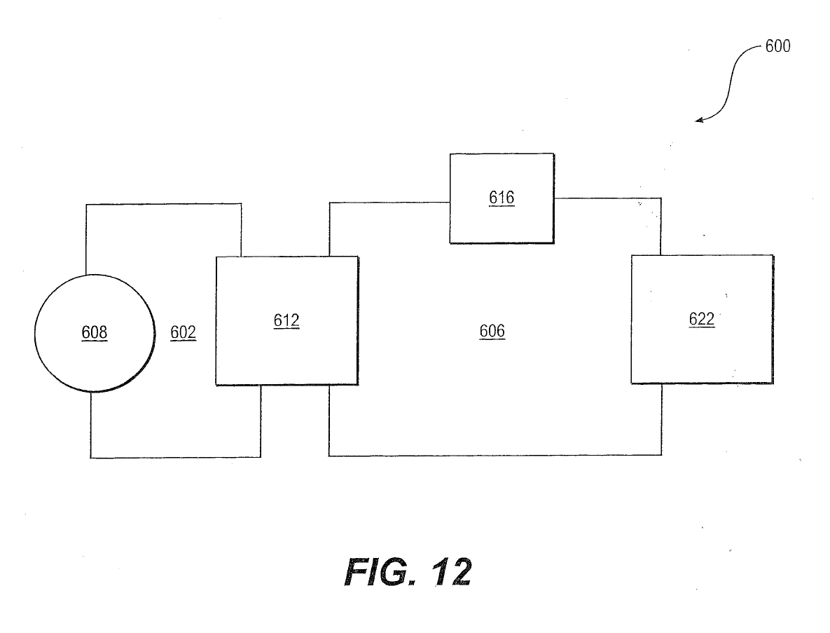

Referring now to FIG. 12, another alternative embodiment of present invention is depicted. Whereas FIG. 11 depicts a system employing a heat source loop in communication with a working fluid loop and the working fluid loop being in communication with the cooling tower loop, 602, 604 and 606 respectively, the embodiment illustrated in FIG. 12 employs only the heat source loop 602 and the cooling tower loop 606. In this embodiment, the heat source loop 602 and cooling tower loop 606 are in direct communication with one another. Moreover, as can be seen in FIG. 12, the thermoelectric device 616 is located on the cooling tower loop 606. Alternatively, the cooling tower loop 606 may also include a heat engine or the like in addition to the thermoelectric device.

During operation the hot fluid is passed through the evaporator or heat exchanger 612 and exits at a temperature which is lower than the temperature with which it entered the evaporator or exchanger 612 and is returned to the power plant 608. Meanwhile the relatively “cool” liquid provided by the cooling tower 622 becomes relatively “hot” and is passed through the thermoelectric device 616 and is discharged at a lower temperature and/or pressure. The thermoelectric device 616 provides electricity, as previously discussed, due to the temperature differential. The water exiting the thermoelectric device 616 is relatively warm cooling fluid and travels to the cooling tower 622. The cooling tower 622 as previously described may have a fan and other associated mechanical systems such as a pump (not pictured), both of which require some mechanical or electrical energy. The cooling tower fluid enters the cooling tower 622, where it is cooled in the cooling tower 622 by contact with ambient air, and exits the cooling tower at a lower temperature than it entered. The lower temperature cooling tower fluid is returned to the condenser or exchanger 612.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for operating a cooling tower system for cooling a heated process fluid, wherein the system employs a component that requires power for operation, comprising:
supplying the process fluid to a heat exchanger to heat a working fluid passing through the heat exchanger;
generating a voltage by passing heat from the working fluid through a thermoelectric device to a heat sink; and
utilizing the cooling tower to cool the working fluid from the thermoelectric device.

2. The method according to claim 1, further comprising the step of generating a power by expansion of the heated working fluid in an expansion engine.

3. The method of claim 1, further comprising the step of providing the generated voltage from the thermoelectric device to the component of the cooling tower system for operation thereof.

4. The method of claim 2, further comprising the step of providing the generated power by the expansion engine to the component.

5. The method of claim 1, wherein the fluid is low pressure steam from a power plant.

6. The method of claim 2, wherein the engine is an organic Rankine engine.

7. The method of claim 1, wherein the thermoelectric device is a thermoelectric chip.

8. The method of claim 1, wherein the component is a fan.

9. The method of claim 2, wherein the expansion engine is an organic Rankine cycle engine.

10. The method of claim 1, wherein the heat sink is air.

11. The method according to claim 1, wherein the heat sink is a fluid.

12. A method for operating a cooling tower system for cooling a heated process fluid, wherein the system employs a component that requires power for operation, comprising:
supplying a cooling tower fluid to a heat exchanger;
supplying the heated process fluid to the heater exchanger, wherein heat exchange occurs between the heated process fluid and the cooling tower fluid whereby said cooling tower fluid cools the heated process fluid and the cooling tower fluid is heated;
generating a voltage by passing the heat from the heated cooling tower fluid through a thermoelectric device to a heat sink; and
utilizing the cooling tower to cool the cooling tower fluid from the thermoelectric device.

13. A cooling tower system for cooling a fluid, the system comprising:
a component that requires power for operation;
a heat exchange device, wherein said heat exchange device includes a thermoelectric device disposed thereon, wherein said thermoelectric device generates a voltage from the heat transferred from the fluid to be cooled to a heat sink that provides at least some of the power required to operate the component.

14. The cooling tower system according to claim 13, further comprising an expansion engine in fluid communication with said heat exchanger.

15. The cooling tower system according to claim 13, wherein the thermoelectric device is a thermoelectric chip.

16. The cooling tower system according to claim 14, wherein the engine is an organic Rankine engine.

17. A cooling tower system for cooling an industrial process fluid, comprising:
a heat source loop connected to a heat source that provides hot fluid;
a working fluid loop thermally connected to said heat source loop via a heat exchange device, wherein said working fluid loop comprises a thermoelectric device; and
a cooling tower fluid loop thermally connected to said working fluid loop wherein said cooling tower fluid loop comprises a cooling tower.

18. The cooling tower system according to claim 17, wherein said working fluid loop further comprises an expansion engine.

19. The cooling tower system according to claim 17, wherein said heat exchange device is a condenser.

20. The cooling tower system according to claim 18, wherein the thermoelectric device is a thermoelectric chip and the engine is an organic Rankine engine.

21. A cooling tower system for cooling an industrial process fluid, comprising:
means for supplying the process fluid to a heat exchange means to heat a working fluid passing through the heat exchange means;
means for generating a voltage by passing the heat from the heated working fluid through a thermoelectric means to a heat sink; and
means for utilizing the cooling tower to cool the working fluid from the thermoelectric means.
